(19) United States
(12) Patent Application Publication
(10) Pub. No.: US 2009/0269078 A1
(43) Pub. Date: Oct. 29, 2009

(54) Dispersion compensator and optical communication device having same

(76) Inventor: Kazunori Miyoshi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/794,672

(22) PCT Filed: Feb. 16, 2006
(86) PCT No.: PCT/JP06/03206

§ 371 Date: Jul. 3, 2007

(30) Foreign Application Priority Data
Feb. 16, 2005 (JP) 2005-039709

(51) Int. Cl. H04B 10/12; H04B 10/00

(52) U.S. Cl. 398/147; 398/159

(57) ABSTRACT

A dispersion compensator (1) has a substrate (2) made of a resin, on which a conductor layer (3a), a dielectric layer (4a), a wiring layer (5a), a dielectric layer (4b), a wiring layer (5b), a dielectric layer (4c), and a conductor layer (3b) are provided in this order. A transmission line (6a) forming the wiring layer (5a) and a transmission line (6b) forming the wiring layer (5b) have identical shapes to each other and have equivalent dispersion characteristics to each other. The transmission lines (6a) and (6b) are formed in a meander shape and are arranged to overlap with each other as viewed in plan. Differential signals (14) and (15) are input to the transmission lines (6a) and (6b), respectively.

### TECHNICAL FIELD

The present invention relates to a dispersion compensator for use in optical communication and an optical communication device having same. In particular, the present invention relates to a dispersion compensator for conducting dispersion compensation processing on an electric signal, and an optical communication device having such a dispersion compensator.

### BACKGROUND ART

In an optical communication system, an optical signal is transmitted between mutually remote points by using an optical fiber. When an optical signal is propagated through an optical fiber, however, the wavelength of the optical signal is deteriorated because the propagation speed differs depending on wavelength components. This phenomenon is referred to as “dispersion”. In recent years, various problems of signal deterioration due to dispersion during transmission of signals through an optical fiber are encountered in technical fields not only of trunk-line optical communication cables, but also of WAN (Wide Area Network), MAN (Metropolitan Area Network) and the like. In order to solve these problems, it is imperative for a recipient to perform dispersion compensation on a received optical signal.

Conventionally, a method of inserting an optical fiber such as a DCF (Dispersion Compensation Fiber) or DSF (Dispersion Shift Fiber) in a transmission line for optical signal is used as a method for dispersion compensation. Recently, EDC (Electrical Dispersion Compensation) is added to the dispersion compensation methods, in which dispersion compensation is performed by an electronic circuitry after an optical signal is converted into an electric signal.

However, the method of using an optical fiber entails increase of transmission cost. As for the EDC, it may be possible to realize dynamic dispersion compensation by using FPGA (Field Programmable Gate Array: programmable LSI) or the like, but will inevitably entail a problem of increased power consumption.

As a dispersion compensator using an electric transmission line, a meander transmission line in which a transmission line is laid in a meander shape is conventionally known (see, for example, Patent Document 1: Japanese Laid-Open Patent Publication No. H05-226901 and Patent Document 2: Japanese Laid-Open Patent Publication No. H05-226902).

FIG. 1A is a plan view showing a conventional dispersion compensator described in Patent Document 1, and FIG. 1B is a cross-sectional view taken along the line B-B′ of FIG. 1A. As shown in FIGS. 1A and 1B, the conventional dispersion compensator 101 has a dielectric substrate 102. One transmission line 103 is provided on the upper face of the dielectric substrate 102. As viewed in a direction vertical to the surface of the dielectric substrate 102 (hereafter, referred to as “viewed in plan”), the transmission line 103 is formed in a meander shape, i.e., a zigzag shape. A conductor layer 104 is provided on the entire area of the lower face of the dielectric substrate 102. The conductor layer 104 is applied with ground potential and functions as a ground layer. Although not shown, an optical signal-electric signal converter is connected to one end of the transmission line 103 (the left side of FIG. 1A), while an electric signal-optical signal converter is connected to the other end (the right side of FIG. 1A).

A received optical signal is converted into an electric signal 111 by the optical signal-electric signal converter, and this electric signal 111 is input to the transmission line 103. A frequency-dependent delay is added to the electric signal 111 by the transmission line 103, whereby the dispersion caused by the optical signal being propagated through optical fiber is compensated. However, the conventional technique described above has problems as follows. The conventional dispersion compensator shown in FIGS. 1A and 1B has low compensation efficiency. When it is assumed, for example, that an optical signal having a transmission speed of 10 Gbps is transmitted by an ordinary single-mode optical fiber having a dispersion value of 0.12 (ps/GHz/km), the transmission line 103 shown in FIG. 1A is required to be 21 cm long in order to compensate the dispersion caused by the transmission in the optical fiber with a length of 256 km. It is very difficult to arrange a transmission line having such a length in an ordinary optical module or on a substrate having an optical module mounted thereon.

The present invention has been made in view of the problems as described above, and it is an object of the invention to provide a dispersion compensator having high compensation efficiency, and an optical communication device having such a dispersion compensator.

### DISCLOSURE OF THE INVENTION

A dispersion compensator according to the present invention is characterized by having an insulating substrate, and a pair of transmission lines which are formed on the substrate and have equivalent dispersion characteristics to each other. The pair of transmission lines are electromagnetically coupled at least partly to each other when electric signals flow therethrough.

The dispersion compensator according to the present invention, which is designed such that a pair of transmission lines are electromagnetically coupled to each other, is able to effectively delay electric signals flowing through these transmission lines. This effect is particularly significant when differential signals flow through the pair of transmission lines.

It is preferable in the dispersion compensator according to the present invention that the pair of transmission lines are formed at least partly in a meander shape. This makes it possible to reduce the size and loss of the dispersion compensator.

It is preferable in the dispersion compensator according to the present invention that the substrate is formed of a resin. This gives flexibility to the dispersion compensator and increases the degree of freedom in arrangement thereof.

The optical communication device according to the present invention is characterized by having the dispersion compensator described above. The optical communication device according to the present invention may have an optical module for converting an input optical signal into an electric signal and outputting the electric signal to the dispersion compensator, and an integrated circuit for performing signal processing on the electric signal output from the dispersion compensator.

### BRIEF DESCRIPTION OF THE DRAWINGS

FIG. 1A is a plan view showing an example of a conventional dispersion compensator;

FIG. 1B is a cross-sectional view taken along the line B-B′ of FIG. 1A;

FIG. 2A is a perspective view showing a pair of transmission lines of a dispersion compensator according to a first embodiment of the present invention;

FIG. 2B is a cross-sectional view of the dispersion compensator according to the first embodiment of the present invention;

FIG. 3 is a graph chart illustrating difference in characteristics between the dispersion compensator according to the first embodiment and a conventional dispersion compensator;

FIG. 4A is a plan view showing a dispersion compensator according to a second embodiment of the present invention;

FIG. 4B is a cross-sectional view taken along the line A-A′ of FIG. 4A;

FIG. 5 is a cross-sectional view showing a dispersion compensator according to a third embodiment of the present invention; and

FIG. 6 is a side view showing an optical communication device according to a fourth embodiment of the present invention.

### BEST MODE FOR CARRYING OUT THE INVENTION

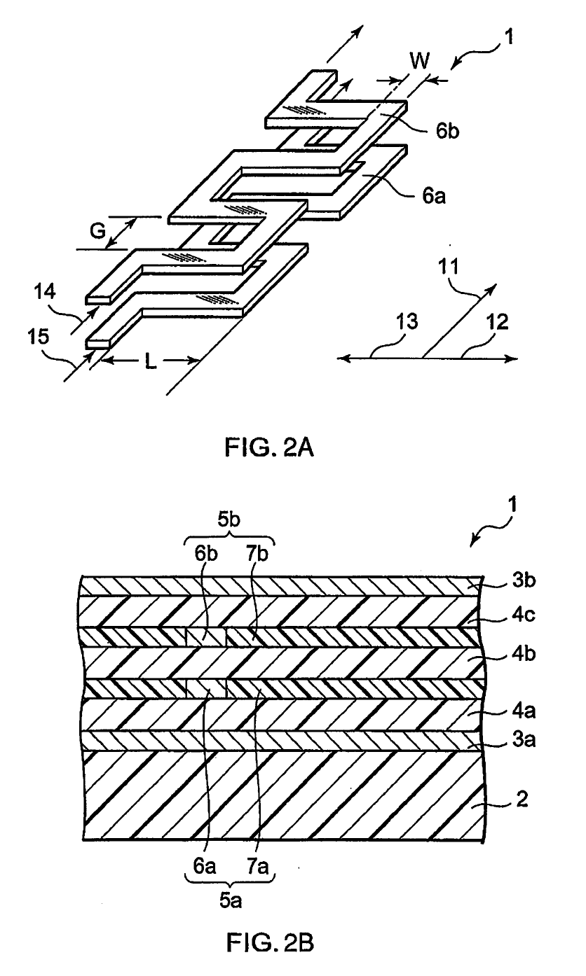

Embodiments of the present invention will be specifically described with reference to the drawings. At first, a first embodiment of the present invention will be described. FIG. 2A is a perspective view showing a dispersion compensator according to the first embodiment, and FIG. 2B is a cross-sectional view of the dispersion compensator shown in FIG. 2A. In FIG. 2A, only transmission lines are shown while other components are omitted for simplification of the drawing.

As shown in FIGS. 2A and 2B, a dispersion compensator 1 according to the first embodiment has a substrate 2 formed, for example, of a resin. A conductor layer 3a of a conductive material is formed on the entire area of the upper face of the substrate 2. A dielectric layer 4a formed, for example, of a resin is provided on the entire surface of the conductor layer 3a. A wiring layer 5a is provided on the dielectric layer 4a. The wiring layer 5a is composed of one transmission line 6a formed of a conductive material, and an insulating material portion 7a filling the periphery of the transmission line 6a. Further, a dielectric layer 4b formed, for example, of a resin is provided on the entire surface of the wiring layer 5a. A wiring layer 5b is provided on the entire area on the dielectric layer 4b. The wiring layer 5b is composed of one transmission line 6b formed of a conductive material, and an insulating material portion 7b filling the periphery of the transmission line 6b. The insulating material portions 7a and 7b are made of a resin, for example. A dielectric layer 4c formed, for example, of a resin is provided on the entire surface of the wiring layer 5b. A conductor layer 3b is provided on the entire surface of the dielectric layer 4c. A multilayer wiring layer is thus formed by the conductor layer 3a, the dielectric layer 4a, the wiring layer 5a, the dielectric layer 4b, the wiring layer 5b, the dielectric layer 4c, and the conductor layer 3b.

The transmission line 6a forming the wiring layer 5a and the transmission line 6b forming the wiring layer 5b are arranged such that they overlap with each other as viewed in a direction vertical to the upper face of the substrate 2, i.e., as viewed in plan. The transmission lines 6a and 6b are formed in a meander shape in their entirety. This means that the transmission lines 6a and 6b are formed into a zigzag shape by sequentially arranging a portion extending in a first direction 11, a portion extending in a second direction 12 orthogonal to the first direction, a portion extending in the first direction 11, and a portion extending in a third direction 13 opposite to the second direction 12, in this order, and repeating this arrangement.

The transmission lines 6a and 6b have identical shapes to each other and equivalent dispersion characteristics to each other. The thicknesses of the wiring layers 5a and 5b are equal to each other, and the insulating material portion 7b is made of a same material as the insulating material portion 7a. In addition, the dielectric layers 4a and 4c have equal thicknesses, and are made of a same material. The dielectric layers 4a and 4c thus have equivalent dielectric constants to each other. Further, the conductor layers 3a and 3b have equal thicknesses and are made of a same material. The dispersion compensator 1 is thus provided with a differential meander-coupled microstrip transmission line.

A description will be made of operation of the dispersion compensator 1 according to the first embodiment configured as described above. Firstly, a ground potential (reference potential) is applied to the conductor layers 3a and 3b. This causes the conductor layers 3a and 3b to serve as ground layers. Differential signals, i.e., electric signals 14 and 15 having opposite polarities are input to the transmission lines 6a and 6b, whereby the transmission line 6a is electromagnetically coupled to the conductor layer 3a, while the transmission line 6b is electromagnetically coupled to the conductor layer 3b. At the same time, the transmission line 6a and the transmission line 6b are electromagnetically coupled to each other along their entire lengths. Since the differential signals flow through the transmission lines 6a and 6b during this time, an electromagnetic field due to the electric current flowing through the transmission line 6a and an electromagnetic field due to the electric current flowing through the transmission line 6b intensify with each other, acting to delay the electric signals flowing through the transmission lines 6a and 6b. Consequently, the electric signals flowing through the transmission lines 6a and 6b can be delayed significantly. This makes it possible to obtain a large dispersion compensation characteristic. The transmission lines 6a and 6b are electromagnetically coupled to each other along their entire lengths, and impedances of the transmission lines 6a and 6b are kept at 100Ω in a certain frequency range. In this manner, the dispersion compensator 1 operates as a dispersion compensator while performing impedance matching as a differential transmission line.

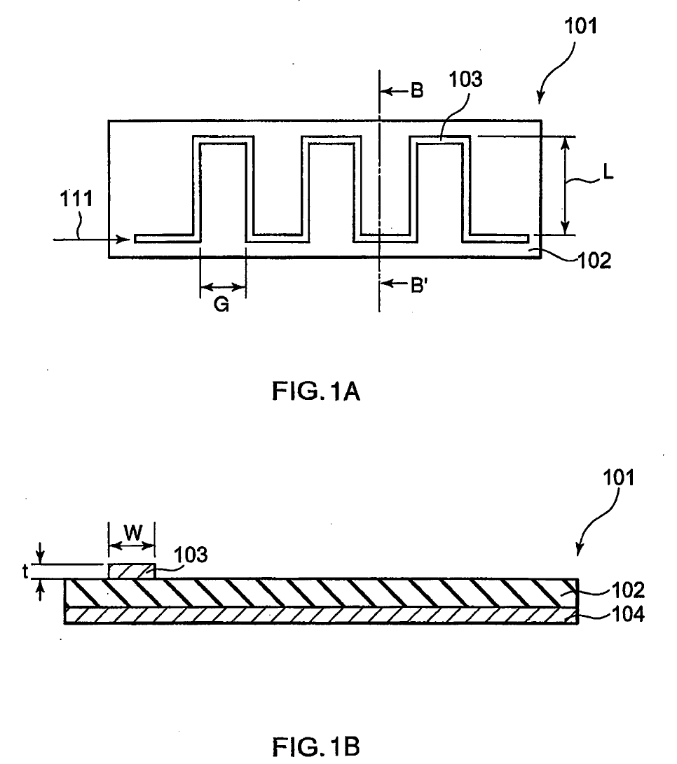

A description will be made of advantageous effects of the dispersion compensator 1 according to the first embodiment. Coupling coefficients of the two transmission lines are denoted by γ and γ′, respectively. A resonance frequency of the transmission line, that is, a frequency at which a meander length L of the transmission line becomes a quarter wave is denoted by f₀. A shift amount of a phase in each loop-back of the transmission line, that is, a phase shift amount for each basic unit of the meander-shaped wiring having a length of (2L+2G) is denoted by θ. In this case, a phase shift amount θ of the conventional dispersion compensator 101 shown in FIGS. 1A and 1B is obtained by the following formula (1). In formula (1), α and β are obtained by the following formulae (2) and (3), respectively. The coupling coefficients γ and γ′ are determined according to the shape of the transmission lines, namely, according to a line width W, a line thickness t, a line-to-line gap G, and a meander length L shown in FIGS. 1A and 1B.

$$\begin{matrix}θ = {cos}^{- 1} [ \begin{matrix}\frac{1 + 2 {γ}^{′}}{6 {γ}^{′}} cos ( \frac{f \times π}{{f}_{0} \times 2} ) + \\ 2 \sqrt{\frac{α}{3}} cos \{ \frac{1}{3} {cos}^{- 1} ( \frac{- β}{2} \times {( \frac{3}{α} )}^{\frac{3}{2}} ) + \frac{4 π}{3} \}\end{matrix} ] & ( 1 ) \\ α = \frac{γ + {γ}^{′} - 1}{2 {γ}^{′}} + \frac{1}{3} {( 1 + \frac{1}{2 {γ}^{′}} )}^{2} {cos ( \frac{f \times π}{{f}_{0} \times 2} )}^{2} & ( 2 ) \\ β = \{ \begin{matrix}\frac{γ + {γ}^{′}}{2 {γ}^{′}} - \\ \frac{( 1 + 2 {γ}^{′} ) \times ( γ + {γ}^{′} - 1 )}{12 {γ}^{′ 2}}\end{matrix} \} cos ( \frac{f \times π}{{f}_{0} \times 2} ) - \frac{2}{27} {( 1 + \frac{1}{2 {γ}^{′}} )}^{3} {cos ( \frac{f \times π}{{f}_{0} \times 2} )}^{3} & ( 3 )\end{matrix}$$

A group delay characteristic τ(=dθ/dω) is obtained according to the following formula (4) by differentiating the formula (1) with respect to an angular speed ω.

$$τ = - \frac{1}{4 {f}_{0}} \times \frac{sin ( \frac{f \times π}{{f}_{0} \times 2} ) ( \frac{γ + {γ}^{′}}{2 {γ}^{′}} - \frac{1 + 2 {γ}^{′}}{2 {γ}^{′}} {cos}^{2} θ )}{sin θ \{ 3 {cos}^{2} θ - \frac{1 + 2 {γ}^{′}}{2 {γ}^{′}} cos ( \frac{f \times π}{{f}_{0} \times 2} ) cos θ - \frac{γ + {γ}^{′} - 1}{2 {γ}^{′}} \}} \qquad ( 4 )$$

On the other hand, a group delay characteristic τ of the dispersion compensator 1 according to the first embodiment shown in FIGS. 2A and 2B is obtained according to the following formula (5), when the coupling coefficient between the transmission line 6a and the transmission line 6b is the same as the coupling coefficient in the loop-back portion in the transmission lines.

$$τ = - \frac{1}{4 {f}_{0}} \times \frac{sin ( \frac{f \times π}{{f}_{0} \times 2} ) ( \frac{2 γ + 2 {γ}^{′}}{4 {γ}^{′}} - \frac{1 + 4 {γ}^{′}}{4 {γ}^{′}} {cos}^{2} θ )}{sin θ \{ 3 {cos}^{2} θ - \frac{1 + 4 {γ}^{′}}{2 {γ}^{′}} cos ( \frac{f \times π}{{f}_{0} \times 2} ) cos θ - \frac{2 γ + 2 {γ}^{′} - 1}{4 {γ}^{′}} \}} \qquad ( 5 )$$

As seen from the formulae (4) and (5) above, the meander-type dispersion compensator can obtain a group delay frequency characteristic as desired by adjusting the line width W, the line thickness t, the line-to-line gap G, and the meander length L.

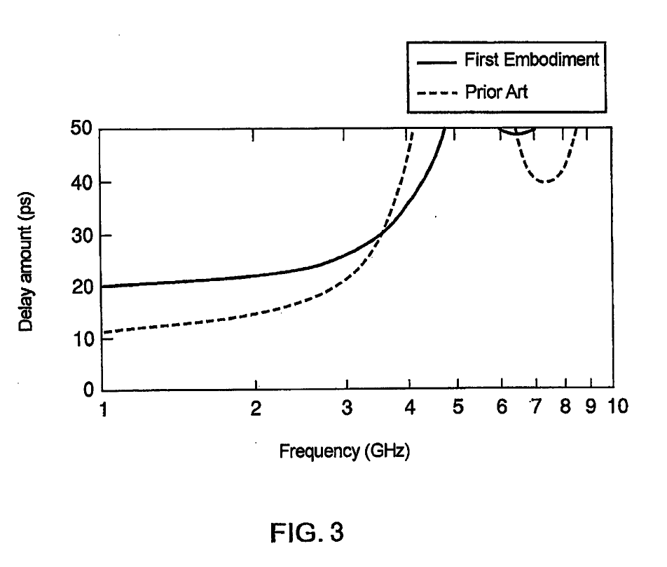

FIG. 3 is a graph chart illustrating a difference in characteristics between the dispersion compensator according to the first embodiment shown in FIGS. 2A and 2B and the conventional dispersion compensator shown in FIGS. 1A and 1B. In FIG. 3, the abscissa axis represents a frequency of an electric signal flowing through the transmission line, and the ordinate axis represents a delay amount corresponding to the frequency. As seen from FIG. 3, the differential dispersion compensator 1 according to the first embodiment is able to obtain a delay amount up to about twice as large as that of the conventional single-wire type dispersion compensator. This means that the dispersion compensator 1 according to the first embodiment is able to obtain a dispersion compensation amount up to about twice as large as that of the conventional dispersion compensator when the lengths of the transmission lines are the same. When a same dispersion compensation amount is to be obtained, the length of the transmission line can be reduced to about a half in the dispersion compensator 1 according to the first embodiment

Additionally, the dispersion compensator 1 according to the first embodiment is able to enlarge the compensation range in comparison with the conventional single-wire type meander transmission line dispersion compensator. Further, since the transmission lines 6a and 6b of the dispersion compensator 1 according to the first embodiment are formed in a meander shape, the reduction of the size and loss can be realized. Still further, since the substrate 2, the dielectric layers 4a to 4c, and the insulating material portions 7a and 7b are formed of a resin, the dispersion compensator 1 is allowed to have flexibility. This for example enables the dispersion compensator 1 to be bent and arranged in a narrow space, giving a high degree of freedom in arrangement thereof.

According to the first embodiment, a dispersion compensator which has a simple and inexpensive structure and yet is highly effective can be provided without providing an expensive DCF or DSF, and without using EDC involving high power consumption.

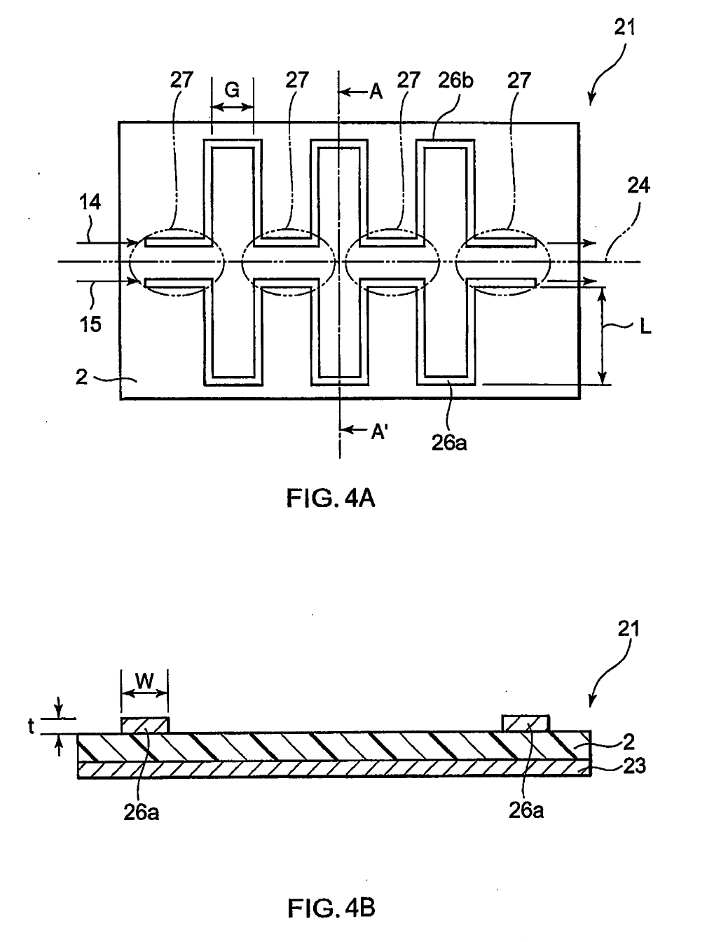

Next, a second embodiment of the present invention will be described. FIG. 4A is a plan view showing a dispersion compensator according to the second embodiment, and FIG. 4B is a cross-sectional view taken along the line A-A′ of FIG. 4A. As shown in FIGS. 4A and 4B, a dispersion compensator 21 according to the second embodiment has a substrate 2 formed, for example, of a resin. Two transmission lines 26a and 26b are provided on the upper face of the substrate 2. The transmission lines 26a and 26b form a single wiring layer on the substrate 2. A conductor layer 23 is provided on the entire area of the lower face of the substrate 2.

The shapes of the transmission lines 26a and 26b are identical to each other, and are formed in a meander shape in the entirety thereof. The transmission lines 26a and 26b are arranged at positions in plane symmetry with respect to a virtual plane 24 that is vertical to the upper face of the substrate 2, whereby their dispersion characteristics are equivalent to each other. Accordingly, there are proximity portions 27 between the transmission line 26a and the transmission line 26b, where they are most proximal to each other. The distance between the transmission line 26a and the conductor layer 23 is equal to the distance between the transmission line 26b and the conductor layer 23.

A description will be made of operation of the dispersion compensator 21 according to the second embodiment configured as described above. Firstly, a ground potential (reference potential) is applied to the conductor layer 23. This causes the conductor layer 23 to function as a ground layer. Differential signals 14 and 15 are then input to the transmission lines 26a and 26b, respectively. Thus, the transmission lines 26a and 26b are electromagnetically coupled to the conductor layer 23, while the transmission line 26a and the transmission line 26b are electromagnetically coupled to each other in the proximity portions 27. Since the differential signals flow through the transmission lines 26a and 26b during this time, an electromagnetic field due to the electric current flowing through the transmission line 26a and an electromagnetic field due to the electric current flowing through the transmission line 26b intensify with each other, acting to delay the electric signals flowing through the transmission lines 26a and 26b. As a result, the electric signals flowing through the transmission lines 26a and 26b can be delayed significantly. Since the transmission lines 26a and 26b are electromagnetically coupled to each other in the proximity portions 27, impedances of the transmission lines 26a and 26b in a certain frequency range are kept, for example, at about 100Ω in the proximity portions 27 where they are electromagnetically coupled. In the portions not coupled, that is, in the portions other than the proximity portions 27, an impedance of each single line is kept, for example, at about 50Ω. In this manner, the dispersion compensator 21 according to the second embodiment operates as a dispersion compensator while performing impedance matching as differential transmission lines.

The dispersion compensator 21 according to the second embodiment is enabled to obtain a desired dispersion compensation characteristic by adjusting the distance between the transmission line 26a and the transmission line 26b, in contrast with the dispersion compensator 1 according to the first embodiment. Additionally, the formation of the transmission lines 26a and 26b on the same face makes it possible to reduce the thickness of the dispersion compensator. Further, since the transmission lines 26a and 26b can be formed simultaneously, the manufacturing process can be simplified. The advantageous effects of the second embodiment other than those described above are the same as those of the first embodiment.

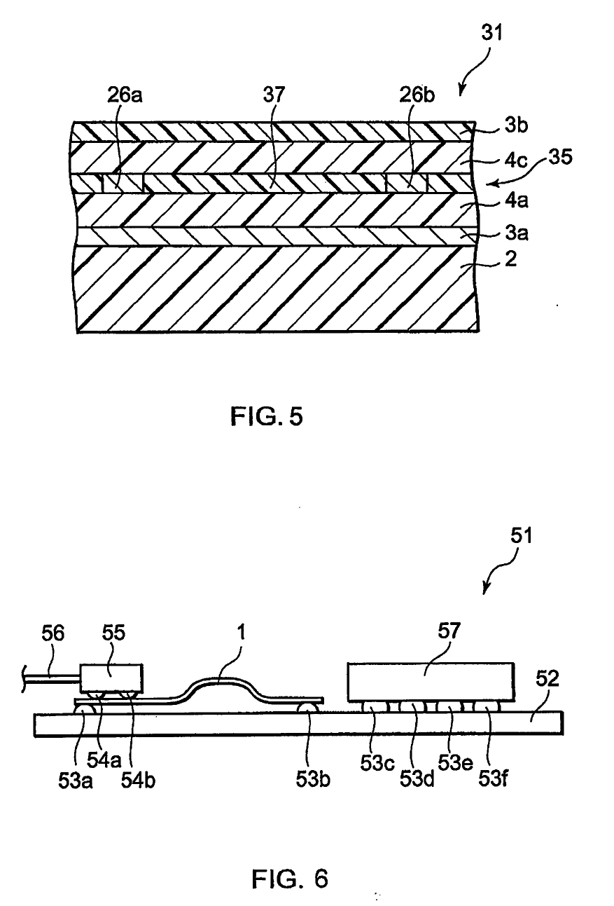

A dispersion compensator according to a third embodiment of the present invention will be described. FIG. 5 is a cross-sectional view showing a dispersion compensator according to the third embodiment. A plan view of the dispersion compensator 31 shown in FIG. 5 will be the same as FIG. 4A. As shown in FIG. 5, the dispersion compensator 31 according to the third embodiment has a substrate 2 formed, for example, of a resin. A conductor layer 3a of a conductive material is provided on the entire area of the upper face of the substrate 2. A dielectric layer 4a formed, for example, of a resin is provided on the entire surface of the conductor layer 3a. A wiring layer 35 is provided on the dielectric layer 4a. The wiring layer 35 is composed of two transmission lines 26a and 26b formed of a conductive material, and an insulating material portion 37 filling the periphery of these transmission lines 26a and 26b. The insulating material portion 37 consists of a resin, for example. Further, a dielectric layer 4c formed, for example, of a resin is provided on the entire surface of the wiring layer 35. A conductor layer 3b is provided on the entire surface of the dielectric layer 4c. Thus, multilayer wiring layer is formed by the conductor layer 3a, the dielectric layer 4a, the wiring layer 35, the dielectric layer 4c, and the conductor layer 3b.

The transmission lines 26a and 26b are identical to the transmission lines 26a and 26b of the second embodiment. The dielectric layers 4a and 4c, which have equivalent thicknesses to each other and are formed of a same material, have dielectric constants equivalent to each other. Still further, the conductor layers 3a and 3b have equivalent thicknesses to each other and are formed of a same material.

A description will be made of operation of the dispersion compensator 31 according to the third embodiment configured as described above. Firstly, a ground potential (reference potential) is applied to the conductor layers 3a and 3b. This causes the conductor layers 3a and 3b to function as ground layers. Differential signals are then input to the transmission lines 26a and 26b, respectively. Thus, the transmission line 26a is electromagnetically coupled to the conductor layers 3a and 3b, and the transmission line 26b is electromagnetically coupled to the conductor layers 3a and 3b. At the same time, the transmission line 26a and the transmission line 26b are electromagnetically coupled to each other in their proximity portions 27 (see FIG. 4A). The operational features and advantageous effects of the third embodiment other than those described above are the same as those of the second embodiment.

Although the above description of the first to third embodiments has been made in terms of an example in which the entirety of the transmission lines is formed in a meander shape, the present invention is not limited to this and the transmission lines may be partly formed in a meander shape.

A fourth embodiment of the present invention will be described. According to the fourth embodiment, an optical communication device is provided. FIG. 6 is a side view showing an optical communication device according to the fourth embodiment. The optical communication device 51 shown in FIG. 6 is a receiver in an optical communication system using an optical fiber. The optical communication device 51 has a wiring board 52. Solder bumps 53a and 53b are provided on terminal pads (not shown) on the wiring board 52. A dispersion compensator 1 is mounted on the wiring board 52 with these solder bumps 53a and 53b interposed therebetween. The dispersion compensator 1 is the dispersion compensator according to the first embodiment described above. The dispersion compensator 1 is curved and arranged compactly on the wiring board 52.

An optical module 55 is mounted on the dispersion compensator 1 with solder bumps 54a and 54b interposed therebetween. An optical fiber 56 is coupled to the optical module 55. An LSI (Large Scale Integrated circuit) for reception amplifier (not shown) is provided in the optical module 55. The optical module 55 converts an optical signal input through the optical fiber 56 into an electric signal and output the electric signal to the dispersion compensator 1 after amplifying the same.

Solder bumps 53c to 53f are further provided on terminal pads (not shown) on the wiring board 52, and an LSI 57 is mounted on the wiring board 52 with the solder bumps 53c, 53d, 53e and 53f interposed therebetween. The solder bump 53b is connected to at least a part of the solder bumps 53c to 53f via a wiring line (not shown) in the wiring board 52. The LSI 57 performs signal processing on an electric signal which is output from the dispersion compensator 1 and input to the LSI 57 via the solder bump 53b and the wiring board 52. The dispersion compensator 1 performs impedance matching between the optical module 55 and the LSI 57.

A description will be made of operation of the optical communication device according to the fourth embodiment configured as described above. An optical signal is propagated through the optical fiber 56 and input to the optical module 55. When input, the wavelength of the optical signal has been deteriorated by dispersion attributable to the optical fiber 56. The optical module 55 converts the input optical signal into an electric signal and outputs the electric signal to the dispersion compensator 1 after amplifying the same. The dispersion compensator 1 performs dispersion compensation on the input electric signal by the operation as described in the first embodiment, and outputs the compensated electric signal to the LSI 57. The LSI 57 performs signal processing on this electric signal.

In the fourth embodiment, the dispersion compensator 1 which is reduced in size and can be curved, can also be mounted on the wiring board 52 on which the optical module 55 is mounted. The other advantageous effects of the fourth embodiment than those described above are the same as those of the first embodiment described above.

Although the description of the fourth embodiment has been made in terms of an example in which the dispersion compensator 1 of the first embodiment described above is used as the dispersion compensator, the present invention is not limited to this, and the dispersion compensator 21 according to the second embodiment or the dispersion compensator 31 according to the third embodiment may be used.

When a required dispersion compensation amount is small, the dispersion compensator of the present invention may be provided in the inside of the LSI. For example, in the fourth embodiment above, the dispersion compensator may be provided in the inside of the LSI for reception amplifier of the optical module 55 or in the inside of the LSI 57. In this case, an interlayer insulation film of the LSI may be used as the substrate for the dispersion compensator, and a wiring line of the LSI may be used as the transmission line. Further, the dispersion compensator of the present invention can be formed easily also on an ordinary circuit board or a flexible resin substrate.

The dispersion compensator according to the present invention is able to effectively delay an electric signal by being provided with a pair of transmission lines which have equivalent dispersion characteristic to each other and are electromagnetically coupled to each other when electric signals flow therethrough, and thus is able to realize high compensation efficiency.

The present invention is suitably applicable to an optical communication device on the reception side of an optical communication system using an optical fiber, and to a dispersion compensator thereof.

1. A dispersion compensator comprising: an insulating substrate, and a pair of transmission lines formed on the substrate, the transmission lines having equivalent dispersion characteristics to each other, and being electromagnetically coupled to each other when electric signals flow therethrough.

2. The dispersion compensator according to claim 1, wherein at least a part of each of the pair of transmission lines is formed in a meander shape.

3. The dispersion compensator according to claim 2, wherein the pair of transmission lines have identical shapes to each other.

4. The dispersion compensator according to claim 3, wherein differential signals flow through the pair of transmission lines.

5. The dispersion compensator according to claim 4, further comprising a multilayer wiring layer provided on the substrate, and wherein the pair of transmission lines form different wiring layers in the multilayer wiring layer, and the pair of transmission lines are arranged to overlap with each other in a direction vertical to the surface of the substrate.

6. The dispersion compensator according to claim 4, further comprising a wiring layer provided on the substrate, and wherein the pair of transmission lines form this wiring layer, and the pair of transmission lines are arranged at symmetrical positions with respect to a plane vertical to the surface of the substrate.

7. The dispersion compensator according to claim 5, wherein the multilayer wiring layer has a pair of conductor layers formed to sandwich the pair of transmission lines through a dielectric layer.

8. The dispersion compensator according to claim 6, further comprising a pair of conductor layers formed to sandwich the pair of transmission lines through a dielectric layer.

9. The dispersion compensator according to claim 6, further comprising conductor layers arranged at positions spaced from the pair of transmission line by equal distances.

10. The dispersion compensator according to claim 7 wherein a reference potential is applied to the pair of conductor layers.

11. The dispersion compensator according to claim 8 wherein a reference potential is applied to the pair of conductor layers.

12. The dispersion compensator according to claim 9, wherein a reference potential is applied to the pair of conductor layers.

13. An optical communication device comprising a dispersion compensator according to claim 1.

14. The optical communication device according to claim 13, further comprising an optical module converting an input optical signal into an electric signal and outputting the electric signal to the dispersion compensator, and an integrated circuit performing signal processing on the electric signal output from the dispersion compensator.

15. The optical communication device according to claim 14, further comprising a wiring board, the dispersion compensator with flexibility being mounted on the wiring board in a curved state.

16. An optical communication device comprising a dispersion compensator according to claim 2.

17. An optical communication device comprising a dispersion compensator according to claim 3.

18. An optical communication device comprising a dispersion compensator according to claim 4.

19. An optical communication device comprising a dispersion compensator according to claim 5.

20. An optical communication device comprising a dispersion compensator according to claim 6.
